(19) United States
(12) Patent Application Publication
(10) Pub. No.: US 2010/0219952 A1
(43) Pub. Date: Sep. 2, 2010

(54) Property Retrieving System

(75) Inventor: Hideto Okamura, Nagano (JP)

Correspondence Address: JORDAN AND HAMBURG LLP, 122 EAST 42ND STREET, SUITE 4000, NEW YORK, NY, 10168, US

(73) Assignee: Totoku Electric Co., Ltd., Shinjuku-ku, Tokyo (JP)

(21) Appl. No.: 12/223,041

(22) PCT Filed: Mar. 10, 2006
(86) PCT No.: PCT/JP2006/304693

§ 371 Date: Jul. 21, 2008

(51) Int. Cl. G08B 13/14

(52) U.S. Cl. 340/572.1

(57) ABSTRACT

An operating unit is fixedly mounted to a property as being accompanied with an active type RF tag unit. When the property to be retrieved is demanded by a user using an upper level unit, its demand is transferred from the upper level unit to an installation type transceiver unit, from the installation type transceiver unit to the active type RF tag unit, and from the active type RF tag unit to the operating unit which then directs the alarming means to emit at least either lights or sounds. This allows the user to recognize the location of the property in a warehouse. When the property is moved, its assigned active type RF tag unit is detached from the operating unit.

### FIELD OF THE INVENTION

The present invention relates to a property retrieving system and more particularly to a property retrieving system capable of easing the action of a user searching the property.

### BACKGROUND OF THE INVENTION

An existence recognizing system has been known where each property is accompanied with a radio tag which emits an electric wave and its existence is recognized when receiving the electric wave from the radio tag (See, for example, Patent Citation 1).

### Patent Citation 1: Japanese Patent Laid-open Publication No 2004-93423.

### DISCLOSURE OF THE INVENTION

### Problems that the Invention is to Solve

For example, properties such as steel materials are stored generally at random in a large warehouse and their location will hardly be identified after a period of time.

It is thus a troublesome task for the conventional existent recognizing system described above to search the property in the large warehouse because the property to be searched is known in the existence in the warehouse but not at the precise location.

It is an object of the present invention to provide a property retrieving system which is capable of easing the action of a user searching the property.

### Means for Solving the Problems

As a first aspect of the present invention, a property retrieving system is provided comprising an operating unit having an alarming means for emitting at least either lights or sounds and an active type RF (radio frequency) tag unit communicating means and fixedly mounted to a property or, e.g., a container for controlling a property, an active type RF tag unit having an operating unit communicating means and a transceiver RF communicating means and detachably mounted to the operating unit, an installation type transceiver unit having an active type RF tag unit RF communicating means and an upper level unit communicating means and installed in a place where the property is stored, and an upper level unit having a command delivering means for, in response to a demand from the installation type transceiver unit communicating means and a user, delivering a command for directing the alarming means in the operating unit assigned to the property to be retrieved to emit at least either lights or sounds.

The property retrieving system of the first aspect can easily retrieve a property in the following manners.

(1) When the upper level unit is operated by a user for retrieving the property, its command is transferred to the installation type transceiver unit and then from the installation type transceiver unit to the active type RF tag unit in the operating unit which in turn directs the alarming means to emit at least either lights or sounds. This allows the user to recognize the location of the property in a warehouse.

(2) When two or more warehouses are provided, the installation type transceiver unit is installed in each of the warehouses. In action, the warehouse where the property to be retrieved is stored can duly be identified with the installation type transceiver unit which has communicated with the active type RF tag unit assigned to the property, hence allowing the user to access the warehouse.

(3) Even when the property is moved together with its operating unit from a warehouse of a company A to a warehouse of another company B, the active type RF tag unit can be detached from the operating unit and reused at the company A. On the other hand, when the operating unit carried away on the property is accompanied with the active type RF tag unit of the company B, it can equally be utilized at the company B for controlling the property. Both the companies A and B can be ensured in the independence for controlling their properties.

In case that the property is moved from the warehouse of the company A to the warehouse of the company B with its operating unit remains at the company A, the active type RF tag unit may be detached and transferred to the company B. In this case unlike the previous case, both the companies A and B can be correlated with each other in the action of controlling their properties.

As a second aspect of the present invention, the property retrieving system of the first aspect may be modified in which the active type RF tag unit communicating means and the operating unit communicating means are implemented by infrared ray communicating means while the upper level unit communicating means and the installation type transceiver unit communicating means are implemented by wire communicating means.

In the property retrieving system of the second aspect, the communication by infrared ray is carried out between the operating unit and the active type RF tag unit while the communication by wireless stands between the active type RF tag unit and the installation type transceiver unit and the communication by wire stands between the installation type transceiver unit and the upper level unit. Accordingly, the communications can be free from interference with each other.

As a third aspect of the present invention, a property retrieving system is provided comprising an operating unit having an alarming means for emitting at least either lights or sounds and an active type RF tag unit communicating means and fixedly mounted to a property or, e.g., a container for controlling a property, an active type RF tag unit having an operating unit communicating means and a transceiver RF communicating means and detachably mounted to the operating unit, and a portable type transceiver unit arranged to be carried by a user and having a command delivering means for, in response to a demand from the active type RF tag unit communicating means and a user, delivering a command for directing the alarming means in the operating unit assigned to the property to be retrieved to emit at least either lights or sounds.

The property retrieving system of the third aspect can easily retrieve a property in the following manners.

(1) When the portable type transceiver unit is operated by a user for retrieving the property, its command is transferred to the active type RF tag unit in the operating unit which in turn directs the alarming means to emit at least either lights or sounds. This allows the user to recognize the location of the property in a warehouse.

(2) When two or more warehouses are provided, the user attempts to communicate with the active type RF tag unit assigned to the property to be retrieved at each of the warehouses. If fails to communicate, the user acknowledges that the property to be retrieved is not stored in the warehouse and can access another warehouse. Accordingly, the action of searching in vain the warehouse where the property is not stored will be avoided.

(3) Even when the property is moved together with its operating unit from a warehouse of a company A to a warehouse of another company B, the active type RF tag unit can be detached from the operating unit and reused at the company A. On the other hand, when the operating unit carried away on the property is accompanied with the active type RF tag unit of the company B, it can equally be utilized at the company B for controlling the property. Both the companies A and B can be ensured in the independence for controlling their properties.

In case that the property is moved from the warehouse of the company A to the warehouse of the company B with its operating unit remains at the company A, the active type RF tag unit may be dismounted and transferred to the company B. In this case unlike the previous case, both the companies A and B can be correlated with each other in the action of controlling their properties.

As a fourth aspect of the present invention, the property retrieving system of the third aspect may be modified in which the active type RF tag unit communicating means and the operating unit communicating means are implemented by infrared ray communicating means.

In the property retrieving system of the fourth aspect, the communication by infrared ray is carried out between the operating unit and the active type RF tag unit while the communication by wireless stands between the active type RF tag unit and the installation type transceiver unit. Accordingly, the communications can be free from interference with each other.

### ADVANTAGES OF THE INVENTION

The property retrieving system according to the present invention allows the operating unit assigned to a property to be retrieved to emit at least either lights or sounds, whereby the action of searching the property in a large warehouse will be eased.

### BRIEF DESCRIPTION OF THE DRAWINGS

FIG. 1 is a schematic view showing a property retrieving system of Embodiment 1;

FIG. 2 is a schematic view showing an operating unit and an active type RF tag unit;

FIG. 3 is a three-side view of the operating unit;

FIG. 4 illustrates a front view, a right side view, and a left side view of the active type RF tag unit;

FIG. 5 illustrates a front view and a side view of the operating unit accompanied with the active type RF tag unit;

FIG. 6 is asthmatic view showing a property retrieving system of Embodiment 2; and

FIG. 7 is an external view of a portable type transceiver unit, in which the primary components are:

10: operating unit, 20: active type RF tag unit, 30: installation type transceiver unit, 40: upper level unit, 50: portable type transceiver unit, 100, 200: property retrieving systems.

### BEST MODES FOR EMBODYING THE INVENTION

The present invention will be described in more detail referring to embodiments shown in the relevant drawings. It wound be understood that the invention is not limited to the embodiments.

### Embodiment 1

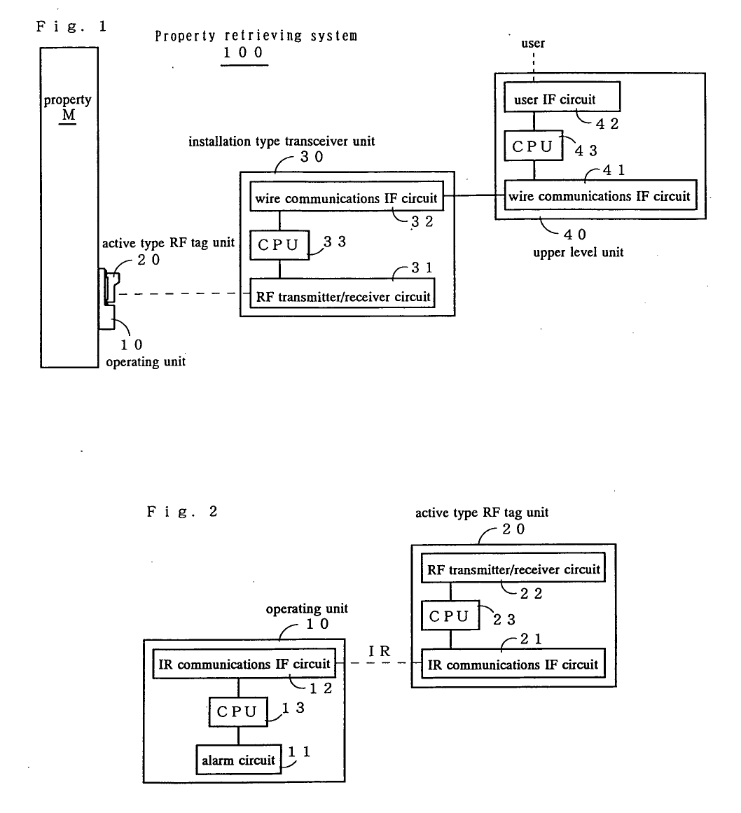

FIG. 1 is a schematic view showing a property retrieving system 100 of Embodiment 1.

The property retrieving system 100 comprises an operating unit 10, an active type RF tag unit 20, an installation type transceiver unit 30, and an upper level unit 40.

The operating unit 10 is fixedly bonded by an adhesive or the like to a property M (or a container or a pallet or a shelf for saving the property).

As shown in FIG. 2, the operating unit 10 comprises an alarm circuit 11 for emitting at least either lights or sounds, an IR (infrared ray) communications IF (interface) circuit 12, and a CPU (central processing unit) 13.

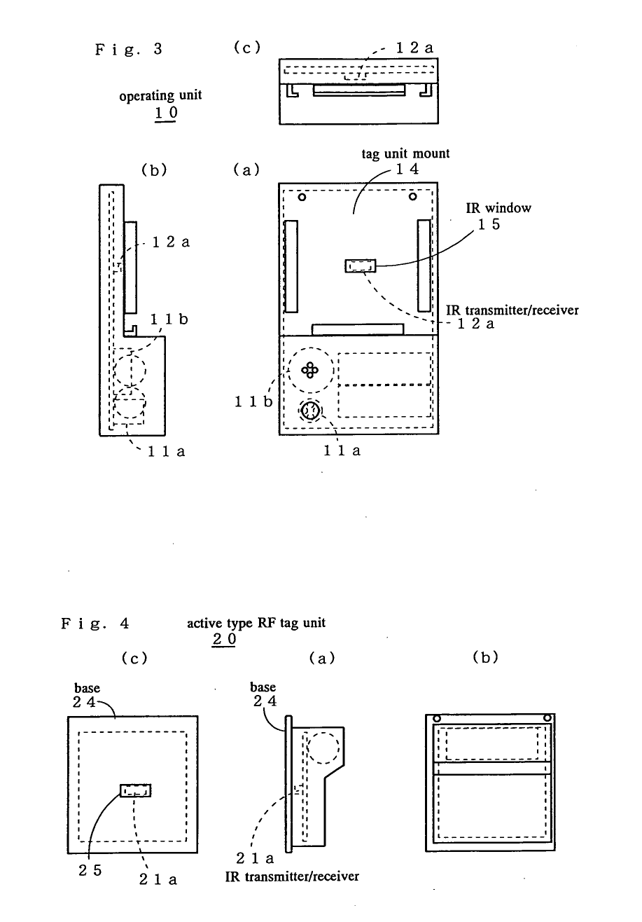

Referring to FIG. 3, the operating unit 10 includes a tag unit mount 14 where the active type RF tag unit 20 is mounted. The tag unit mount 14 has an IR window 15 provided therein. An IR transmitter/receiver (a combination of infrared ray light emitting diode and infrared ray photo transistor) 12a is disposed just beneath the IR window 15. The IR transmitter/receiver 12a is a member of the IR communications IF circuit 12.

A visible light emitting diode array 11a and an electronic buzzer 11b are members of the alarm circuit 11.

The operating unit 10 is energized by a lithium primary cell.

Returning to FIG. 2, the active type RF tag unit 20 comprises an IR communications IF circuit 12, an RF transmitter/receiver circuit 22, and a CPU 23.

As shown in FIG. 4, the active type RF tag unit 20 has an IR window 25 provided in the bottom side thereof. An IR transmitter/receiver 21a is disposed just beneath the IR window 25. The IR transmitter/receiver 21a is a member of the IR communications IF circuit 21.

The active type RF tag unit 20 is energized by a lithium primary cell.

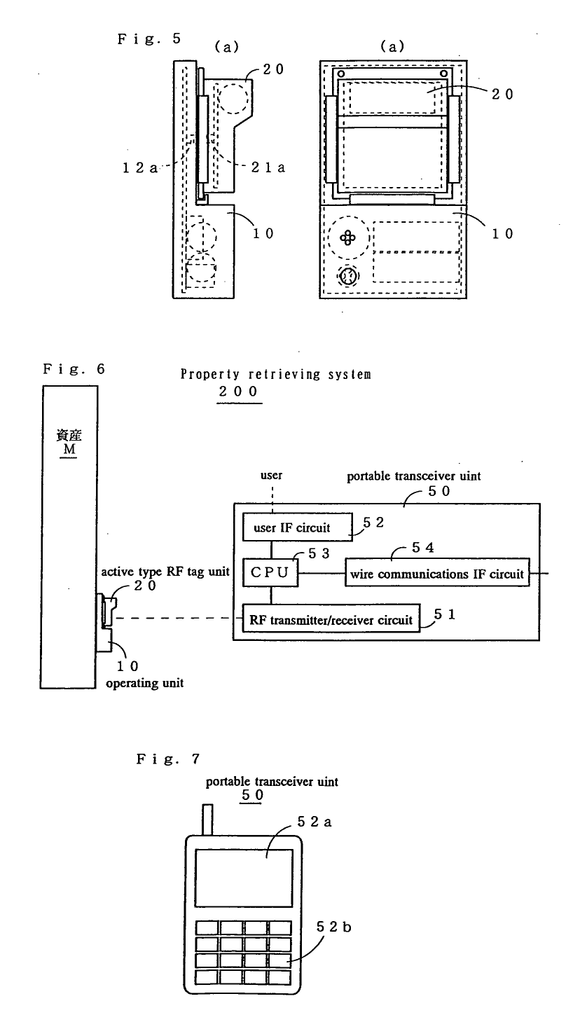

When the operating unit 10 is joined with the active type RF tag unit 20 as shown in FIG. 5, its IR transmitter/receiver 12a comes to face the IR transmitter/receiver 21a of the active type RF tag unit 20, thus allowing the two transmitter/receivers to be communicated with the use of infrared ray.

The installation type transceiver unit 30 is disposed in each warehouse.

Returning to FIG. 1, the installation type transceiver unit 30 comprises an RF transmitter/receiver circuit 31, a wire communications IF circuit 32, and a CPU 33.

The wire communications IF circuit 32 may be implemented by a LAN interface circuit.

The upper level unit 40 comprises a wire communications IF circuit 41, a user IF circuit 42, and a CPU 43.

The user IF circuit 42 includes a display and an input device for communication with the user.

The upper level unit 40 may be implemented by a commonly available computer.

In brief, while one or more of the installation type transceiver units 30 are disposed beneath the upper level device 40, one or more of the active type RF tag units 20 are disposed beneath the installation type transceiver unit 30 and the single operating unit 10 is disposed beneath the active type RF tag unit.

The action of the property retrieving system 100 for searching a property will be described below.

(1) The action starts with the user specifying the property to be retrieved with the use of the upper level unit 40.

(2) The upper level unit 40 inquiries one or more of the installation type transceiver units 30 and instructs the user to go a warehouse where the installation type transceiver unit 30 which has been communicated with the active type RF tag unit 10 assigned to the property to be retrieved is present.

(3) The user goes to the warehouse.

(4) Meanwhile, the upper level unit 40 commands the installation type transceiver unit 30 which has been communicated with the active type RF tag unit 10 assigned to the property to be retrieved, the installation type transceiver unit 30 commands the active type RF tag unit 20 assigned to the property to be retrieved, and the active type RF tag unit 20 commands the operating unit 10.

(5) The operating unit 10 directs the visible light emitting diode array 11a to emit lights and the electronic buzzer 11b to emit sounds.

(6) The user then recognizes from the lights and sounds the location of the property in the warehouse.

The action of transferring a property M from one ware house at a company A to another warehouse at a company B will be described.

(1) The property is dispatched from the company A when its active type RF tag unit 20 has been detached from the operating unit 10. The detached active type RF tag unit 20 can be reused at the company A.

(2) The property received by the company B is then tagged with an active type RF tag unit 20 of the company A. The property can be controlled by the property retrieving system 100 of the company B. The property control at the company A and the property control at the company B can thus be ensured respectively in the independence.

When the operating unit 10 is fixed to an not-movable installation such as a shell where the property M to be delivered is stored, the active type RF tag unit 20 is detached from the operating unit 10 and another active type RF tag unit 20 assigned to a property to be newly stored is attached to the operating unit 10. Accordingly, the property to be stored at the company A can be controlled.

The detached active type RF tag unit 20 may be carried on the property M to be delivered. In this case unlike the above described case, the property control at the company A and the property control at the company B can be communicated with each other.

### Embodiment 2

FIG. 6 is a schematic view Showing a property retrieving system 200 of Embodiment 2.

The property retrieving system 200 comprises an operating unit 10, an active type RF tag unit 20, and a portable transceiver unit 50.

The portable transceiver unit 50 comprises an RF transmitter/receiver circuit 51, a user IF circuit 52, a CPU 53, and a wire communications IF circuit 54.

As Shown in FIG. 7, the portable transceiver unit 50 also includes an LCD 52a and a group of entry keys 52b. The LCD 52a and the entry keys 52b are members of the user IF circuit 52.

The wire communications IF circuit 54 may be implemented by a USB interface circuit.

The action of the property retrieving system 200 for searching a property will be described below.

(1) The action starts with a user specifying the property to be retrieved with the use of the portable transceiver unit 50.

(2) The user moves into a warehouse and starts its retrieving action with the portable transceiver unit 50.

(3) If the portable transceiver unit 50 fails to communicate with the active type RF tag unit 10 assigned to the property to be retrieved, it directs the user to move into another warehouse.

(4) The user moves into the another warehouse and repeats its retrieving action from the step (2).

(5) When the portable transceiver unit 50 starts communicating with the active type RF tag unit 10 assigned to the property to be retrieved, its command is transferred to the active type RF tag unit 20 and from the active type RF tag unit 20 to the operating unit 10.

(6) The operating unit 10 directs the visible light emitting diode array 11a to emit lights and the electronic buzzer 11b to emit sounds.

(7) The lights and sounds allow the user to recognize the location of the property in the warehouse.

The portable type transceiver unit 50 may be connected by the wire communications IF circuit 54 to an upper level unit for conducting a communicating action such as downloading of a data required for controlling the properties from the upper unit.

### INDUSTRIAL APPLICABILITY

The property retrieving system according to the present invention can favorably be used for controlling the properties of large sizes such as steel materials.

What is claimed is:

1. A property retrieving system comprising an operating unit having an alarming means for emitting at least either lights or sounds and an active type RF tag unit communicating means and fixedly mounted to a property or, e.g., a container for controlling a property, an active type RF tag unit having an operating unit communicating means and a transceiver RF communicating means and detachably mounted to the operating unit, an installation type transceiver unit having an active type RF tag unit RF communicating means and an upper level unit communicating means and installed in a place where the property is stored, and an upper level unit having a command delivering means for, in response to a demand from the installation type transceiver unit communicating means and a user, delivering a command for directing the alarming means in the operating unit assigned to the property to be retrieved to emit at least either lights or sounds.

2. A property retrieving system according to claim 1, wherein the active type RF tag unit communicating means and the operating unit communicating means are implemented by infrared ray communicating means while the upper level unit communicating means and the installation type transceiver unit communicating means are implemented by wire communicating means.

3. A property retrieving system comprising an operating unit having an alarming means for emitting at least either lights or sounds and an active type RF tag unit communicating means and fixedly mounted to a property or, e.g., a container for controlling a property, an active type RF tag unit having an operating unit communicating means and a transceiver RF communicating means and detachably mounted to the operating unit, and a portable type transceiver unit arranged to be carried by a user and having a command delivering means for, in response to a demand from the active type RF tag unit communicating means and a user, delivering a command for directing the alarming means in the operating unit assigned to the property to be retrieved to emit at least either lights or sounds.

4. A property retrieving system according to claim 3, wherein the active type RF tag unit communicating means and the operating unit communicating means are implemented by infrared ray communicating means.
